(19) United States
(12) Patent Application Publication
(10) Pub. No.: US 2014/0376240 A1
(43) Pub. Date: Dec. 25, 2014

(54) Counter weighted hinged light pole

(71) Applicant: Michael Richardson, Bridgeport, TX (US)

(72) Inventor: Michael Richardson, Bridgeport, TX (US)

(21) Appl. No.: 13/986,992

(22) Filed: Jun. 21, 2013

(51) Int. Cl. F21V 21/116

(52) U.S. Cl. CPC F21V 21/116
USPC 362/431

(57) ABSTRACT

The invention disclosed herein is a counter weighted hinged light pole which allows easy access to the light fixtures and other devices attached at the top of the light pole to be accessed. The counter weighted hinged light pole consists of a support base, a central support pole which is attached to the base and which has a hinge located at the end opposite the base. A top pole to which the lights and other devices are attached is affixed to the hinge. A second bottom member is also attached to the hinge and is an extension of the top pole in the opposite direction. A counter weight approximating the weight of the light fixtures is attached to the end of the second bottom member. A rope attached to the end of the top pole near the light fixtures enables a worker to lower the light fixtures by applying tension to the rope. The top of the top pole rotates in a downward arc around the hinge.

### CROSS-REFERENCE TO RELATED APPLICATIONS

This application claims benefit of and priority to U.S. Provisional Patent Application No. 61/690,261 filed on Jun. 22, 2012 which is incorporated herein by reference as if fully set forth.

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

None

### REFERENCE TO A SEQUENCE LISTING

Not applicable.

### BACKGROUND OF THE INVENTION

1. Field

The field of the disclosed invention is the maintenance lights and other devices located on the top of tall utility and light poles.

2. Description of the Prior Art

Lights and other devices mounted to the top of utility poles have become almost a ubiquitous sight wherever outdoor lighting is required. Lights mounted atop utility poles are found at worksites, recreation areas, parking lots, schools, businesses, parks, athletic fields, along streets and roads and many other locations. These lights require periodic maintenance to replace failed light bulbs, defects in the light fixtures or other problems. Because these lights may be mounted on poles and be well off of the ground, accessing the lights is problematic. The worker can climb the pole to access the light fixtures. However, such is a dangerous activity and the poles may not be constructed to support the worker's weight. The worker may fall from the pole and suffer severe injuries or the pole can buckle under the worker's weight, damaging the pole and/or injuring the worker. Devices have been developed to lower the light fixtures to the ground so that they can be safely repaired and maintained. One of these devices employs a winch located on the ground which is attached by cable to the bull horn or bar to which lights and other devices can be mounted. The bull horn is designed and constructed so that the bull horn to which the lights are attached may be lowered to the ground for maintenance by way of the winch. Another device employs a hinge placed approximately in the middle of the utility pole which acts as a pivot point or “see-saw”. A winch is attached to the bottom of the pole and the winch cable is attached to the bottom of the utility pole. The winch cable is slowly extended allowing the bull horn attached to the top of the utility pole to rotate about the axis of the hinge and come down due to the weight of the bull horn. At the same time the bottom frames of the utility pole rises in an arc on the opposite side of the hinge in concert with the downward rotation of the top of the utility pole bearing the bull horn. The utility pole can be lowered to a height for convenient access. Winches sometimes fail, may be expensive and difficult to use.

Another method employed to access the bull horn bearing the light fixtures is known as a “cherry picker” which consists of a bucket attached to a hydraulic arm which can be raised and lowered. The hydraulic arm is usually attached to a truck or other vehicle. The worker stands in the bucket and is raised by the hydraulic arm to the level of the bull horn for maintenance of the lights. These devices are expensive and limited in the height to which it can reach. What is needed in the art is a convenient and safe method to access the bull horn bearing the light fixtures and other devices located atop a light pole.

### BRIEF DESCRIPTION OF THE PRESENT INVENTION

The invention disclosed herein is a device which provides a convenient and safe method to access the bull horn bearing the light fixtures and other devices located atop a light pole. Specifically, the invention disclosed herein is a counter weighted hinged light pole. A rope or cable is attached to the bull horn located at the top of the light pole. When the lights and other devices require maintenance, a worker applies tension to the rope or cable and the bull horn rotates downward around the axis created by the hinge lowering the top of the light pole for easy access. Because the end opposite the top of the light pole is counterweighted, little effort is required by the worker to lower the bull horn for access. Once the lights and other devices located on the bull horn at the top of the light pole have been serviced, the light pole can be returned to the upright position by lessening the tension on the rope or cable attached to the top of the light pole allowing the top of the light pole to rotate upward in concert with the downward rotation of the bottom of the light pole aided by the counter weight.

### DESCRIPTION OF THE DRAWING FIGURES

A better understanding of the counter weighted hinged light pole disclosed herein may be had by examination of the following drawing/figures:

FIG. 1 shows the counter weighted hinged light pole at full extension.

FIG. 2 shows the top of the counter weighted hinged light pole partially lowered.

FIG. 3 shows the top of counter weighted hinged light pole fully lowered.

FIG. 4 shows the bull horn to which lights are attached fully lowered.

### DETAILED DESCRIPTION OF THE PRESENT INVENTION

The invention disclosed herein is a counter weighted hinged light pole. The advantage of this invention is that it provides easy, safe and convenient access to the top of the light pole where the lights and other devices are located. By pulling on a rope or cable attached to the top of the light pole, a worker can lower the top of the pole in a manner similar to the operation of a “see saw”. The bottom portion of the light pole is counter weighted to closely approximate the weight of the bull horn and attached devices so that the top and bottom of the utility pole rotate smoothly about the axis created by the hinge located in approximately the center of the utility pole.

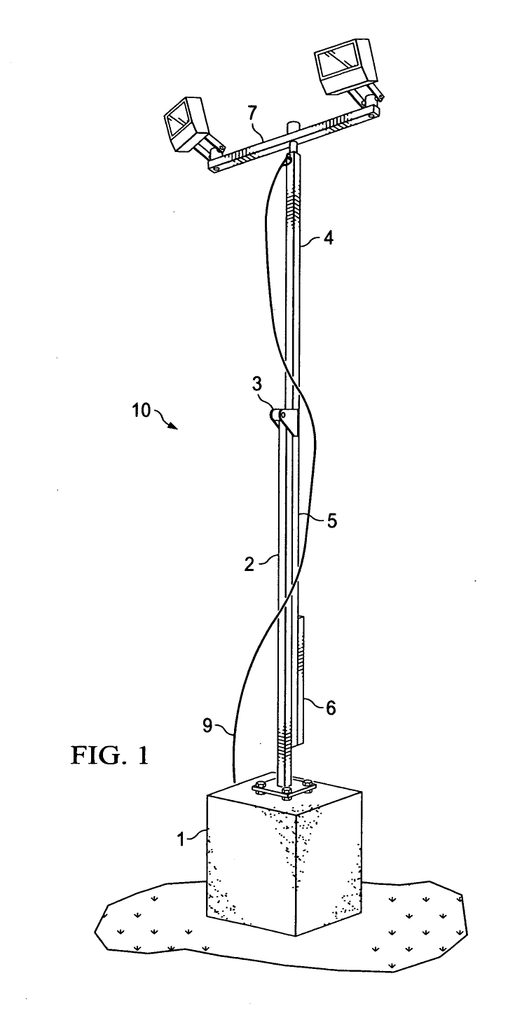

As shown in FIG. 1, the counterweighted hinged light pole 10 consists of a base 1 upon which the counterweighted hinged light pole 10 rests, a bottom portion which consists of a central support pole 2 to which a hinge 3 is attached at the end of the central support pole 2 distal to the base 1. A bottom second member 5 is attached to the top pole 4 hinge 3 and is configured to fit around three sides of the central support pole 2. Attached at the end of the bottom second member 2 proximal to the ground is located one or more counterweights 6. The top pole 4 is attached bottom second member 5 at the hinge 3 in a vertical configuration from the central support pole 2 and the bull horn 7 is attached to the top pole 4 at a position distal to the portion of the top pole 4 attached to the hinge 3. This arrangement permits the top pole 4 and bottom second member 5 to rotate in an arc about the axis created by the hinge 3 like a “see saw”. At the top of the top pole 4 is the bull horn 7 to which lights and other devices may be attached. A rope or cable 9 is attached to the top of the top pole 4 to allow the bull horn 7 to be pulled in a downward arc toward the ground. The bottom second member 5 positioned next to the central support pole 2 rotates upward in concert with the downward rotation of the bull horn 7. The counter weight 6 attached to the bottom second member 5 permits the bull horn 7 to rotate downward smoothly and safely to a position for easy and safe access. The counter weight 6 is constructed to be of approximately the same weight as the bull horn 7.

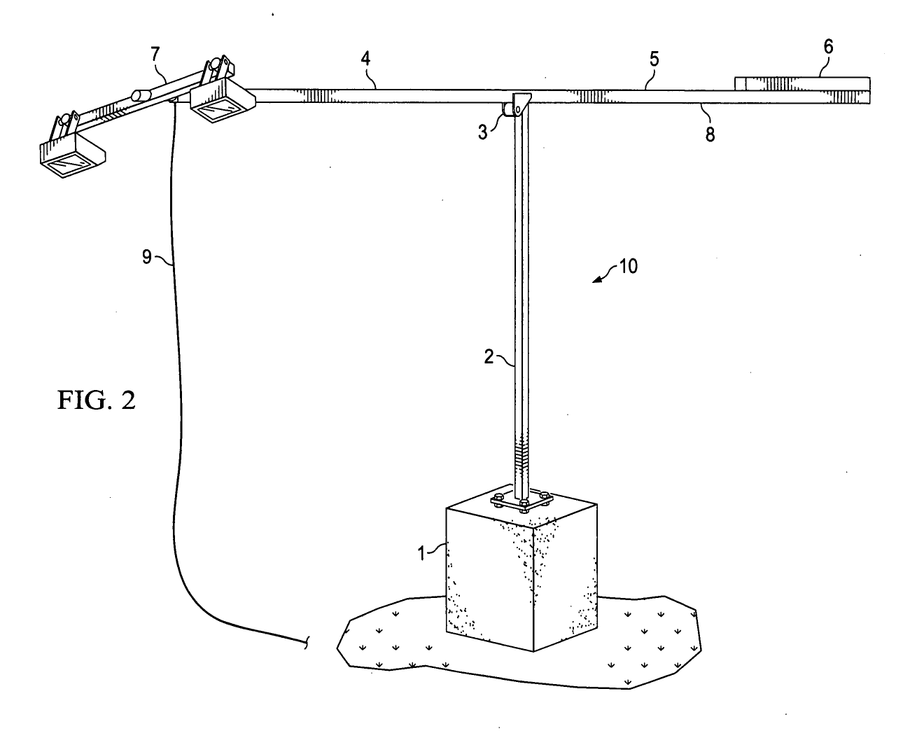

FIG. 2 shows the counter weighted hinged light pole 10 in which the bull horn 7 has been rotated downward approximately 90° in an arc by a rope or cable 9 and the bottom second member 5 to which the counter weight 6 is attached, rotates upward approximately 90° in an arc in concert with the top portion 4 of the light pole. Both the top of the top pole 4 and the bottom of the bottom second member 5 rotate in concert about the axis created by the hinge 3. Because the counter weight 6 closely approximates the weight of the bull horn 7 with attached lights and devices, the top pole 4 and bottom second member 5 move smoothly and safely through their arcs and rotate about the hinge 3. The bottom second member 5 is designed and constructed form a three sided shaft 8 which allows the bottom second member 5 to fit around the central support pole 2 when the counter weighted hinged light pole 10 is in full upright position.

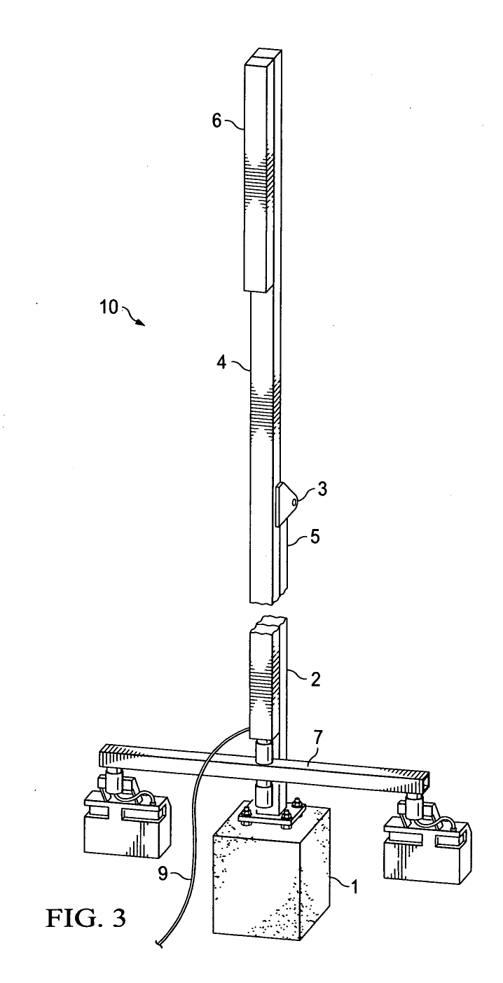

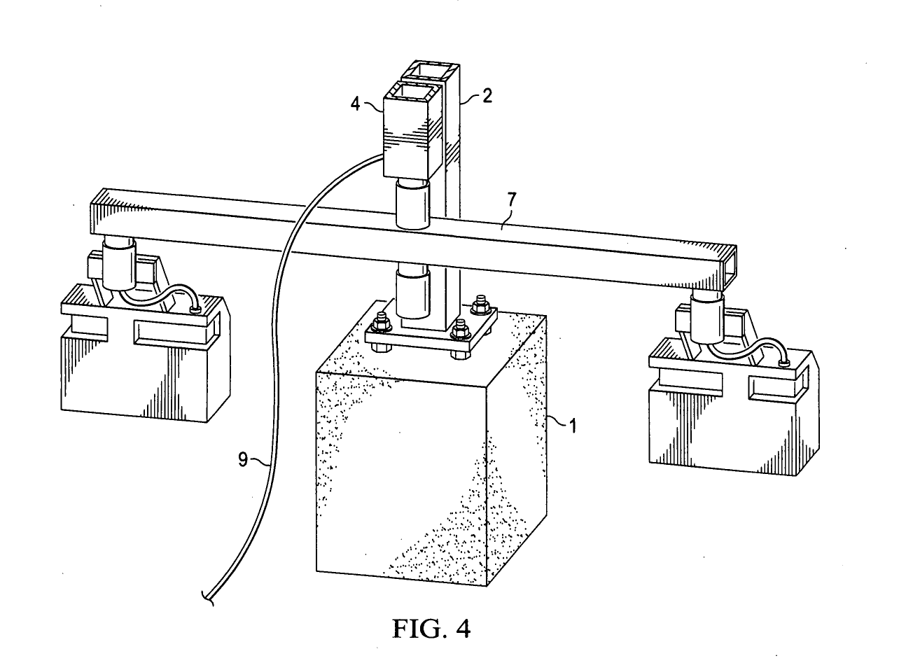

Once the bull horn 7 containing the lights and other devices has been lowered completely, the bull horn 7 attached to the top pole 4 is now located against the base 1 as shown in FIGS. 3 and 4. The bottom second member 5 to which the counter weight 6 is attached is now located at the top of the arc defined by the hinge 3 in the position previously occupied by the bull horn 7. At this point the lights and other devices may be safely maintained by a worker who can remain on the ground. Such not only contributes to safety but should the worker need additional tools or parts, such are conveniently located nearby permitting the worker to remain on the ground rather than climbing down from the light pole to retrieve parts or tools.

The counter weighted hinged light pole is susceptible to many different sizes and configurations. The length of the components of counter weighted hinged light pole can be manufactured and configured for assembly of counter weighted hinged light poles of various heights depending on the application. Likewise, the counter weight can be of various weights to accommodate various weights of the devices attached to the bull horn. Heavier counterweights can be attached to offset heavier devices attached to the bull horn. Additional counter weights may be added to closely approximate the weight of the bull horn to which lights and other devices are attached. Conversely, lighter counter weights can balance the light pole when lighter devices are attached to the bull horn. These additional embodiments of the counterweighted hinged light pole are incorporated into this specification and as further defined by the claims appended hereto.

Many different devices may be attached to the bull horn of the counter weighted hinged light pole. Those devices may include singly or in combination, lights of various sizes, traffic lights, solar panels, horns, speakers, cellular antennas, satellite antennas, radio antennas, microwave antennas, transformers, still and video surveillance cameras and most any device which needs to be mounted on a utility pole for optimum performance. The shaft supporting electricity producing wind mills could also be constructed with the counter weighted hinged light pole design. This adaptation of the invention disclosed herein would permit safe and convenient service of the turbine and windmill blades. The counter weighted hinged light pole would enable safe and convenient maintenance and repair of any device mounted located at the top of tall pole.

In yet another embodiment of the invention disclosed herein, the counter weight can be attached to the bottom second member on an adjustable rail so that the counter weight can be positioned at many points on the bottom second member. The counter weight can then be moved along the bottom second member to “fine tune” the balance of the counter weighted hinged light pole.

The counter weighted hinged light pole could also be attached to ships and boats. Marine antennas, lights, speakers, horns and other devices mounted on the bull horn of a counter weighted hinged light pole attached to a ship would be permit safe and convenient repair and maintenance by the crew of the ship or boat.

I claim:

1. A counter weighted hinged light pole which facilitates access to light fixtures attached to the top of the light pole comprising:
a base;
a central support pole attached to said base and extending upward from said base;
a hinge attached to the top of said central support pole at a position distal from said base;
a top pole attached to said hinge;
a second bottom member attached to said top pole at said hinge and extending distally away from said top pole;
a plurality of light fixtures attached to the distal end from said hinge on said top pole;
a rope attached to the distal end of said top pole distal from said hinge.

2. A counter weighted hinged utility pole which facilitates access to utility fixtures attached to the top of the utility pole comprising:
a base;
a central support pole attached to said base and extending upward from said base;
a hinge attached to the top of said central support pole at a position distal from said base;
a top pole attached to said hinge;
a second bottom member attached to said top pole at said hinge and extending distally away from said top pole;
a plurality of light fixtures attached to the distal end from said hinge on said top pole;
a rope attached to the distal end of said top pole distal from said hinge.

3. The counterweighted hinged utility pole defined in claim 2 wherein said utility fixture is an antenna.

4. The counterweighted hinged utility pole defined in claim 2 wherein said utility fixture is a camera.

5. The counterweighted hinged utility pole defined in claim 2 wherein said utility fixture is an audio speaker.

6. The counterweighted hinged utility pole defined in claim 2 wherein said utility fixture is an electrical transformer.

7. The counterweighted hinged utility pole defined in claim 2 wherein said utility fixture is a horn.
